(19) United States
(12) Patent Application Publication
(10) Pub. No.: US 2004/0032334 A1
(43) Pub. Date: Feb. 19, 2004

(54) Doze-off early warning system for automotives and other applications

(76) Inventor: Ataul Haq, Alexandria, VA (US)

Correspondence Address: ATAUL HAQ, 5340 HOLMES RUN PKWY. #1412, ALEXANDRIA, VA, 22304, US

(21) Appl. No.: 10/639,625

(22) Filed: Aug. 13, 2003

Related U.S. Application Data
(60) Provisional application No. 60/402,731, filed on Aug. 13, 2002.

(51) Int. Cl. G08B 23/00

(52) U.S. Cl. 340/575

(57) ABSTRACT

The present invention is to provide a convenient way to alarm a driver of the vehicle, especially for long distance driving, during the doze-ff condition that could exist while driving under the influence of fatigue or substance consumed. This invention is simple and retrofit able. This invention can also be built into the vehicle system in case of original equipment manufacturer. The doze-off early warning system operates on a low voltage current, that can be provide with a conventional battery or could be connected to the steering column power source. Some visual indicators are provided and an effective audio and visual alarm system is incorporated into the system. The alarming process is based on the forefinger pressure of the driver on the steering wheel grip. As the grip is relaxed the system goes into alarm mode. After series of time delay and analysis the alarm goes off to alert the driver of the dangerous condition. The system receives feed-back from other system of the vehicle. In case of retrofit models, the system acts on certain predetermined time delay and some data stored during learning mode.

This invention will bring safety on our roads. This problem of dozing-off on the wheel exist since the inception of automotive. The problem is becoming more prevalent due to long hours of driving and stressful work. This simple device can be manufactured very economically due to the very simple innovative idea. Thereby, bringing unparallel device to consumer for their ultimate safety on the roads.

### CROSS-REFERNCE TO THE RELATED ART

This application claims the benefit of U.S. Provisional Patent Application Serial No. 60/402,731 filed on Aug. 13, 2002.

### BACKGROUND OF THE INVENTION

1. Field of the Invention

The present invention relates to automotive safety and more particularly an early warning system for automotive and other applications, to alert the driver in the event of doze-off on the steering wheel while driving.

2. Description of Prior Art

So far several invention have been made to address doze-off conditions while driving, by devising systems that could prompt the driver of the dangerous condition. However, so far every invention proved to be inherently not practical or not economical to manufacture.

This present invention is however, very practical and very economical to manufacture. Further more it is retrofit able to any existing vehicle. This invention is based on the natural behavior of person about to doze-off on the steering wheel of the vehicle.

The invention of Sutherland; Roland L, U.S. Pat. No. 6,218,947 dated Apr. 17, 2001 is based on the condition of complete hands free from the steering wheel. Moreover, the system is so complicated that it is not economical to manufacture and chances of the system mal function are very high. It is further known that his system is only possible with original equipment manufacturer to install in new models.

The invention of Tschoi; Jin Sook U.S. Pat. No. 5,969,616 dated Oct. 19, 1999 uses pressure theory, however in one embodiment the pressure transmitter is hydraulic or pneumatic element. Obviously hydraulic or pneumatic element are complicated and are prone to leak out making the system non-functional in the event of danger. In another embodiment the pressure transmitter is a spring-biased element. The position of this element is in question. Every driver has his own way of holding the steering wheel, and drivers tend to change the steering grip position during driving. Yet in another embodiment the pressure element is a center conductor surrounded by a compressible conductor element, which seem to be not practical.

### BRIEF SUMMARY OF THE INVENTION

The present invention “Doze-off early warning system for automotive and other applications” is drawn to a simple, rugged and yet very economical warning system which is retrofit able to any existing vehicle, and can be installed very easily. This doze-off early warning system operates on variable pressure of the forefingers of the driver driving attentively or driving inattentively or about to doze-off on the steering wheel. It is an absolute natural tendency to relax the forefinger grip as soon as attentiveness is absent or mind is about to sleep.

This invention uses a hollow collapsible-flexible tube of certain thickness having two conductive elements attached/fixed inside of the hollow tube face to face along the whole length of the tube. The tube thickness and material is such that a normal grip on the steering wheel, at any position, will compress the tube, therefore making a conductive connection. The tube is glued (self adhesive type) on the back side of the steering wheel where forefingers of a normal grip would rest, all along the circumference of the steering wheel.

An small electronic solid state module with audio-visual alarming signals is placed on the web of the steering wheel. The module is connected to the pressure sensitive hollow tube by means of fine electrical connection via micro plug. This module can be a self powered using small standard battery or can have power drawn from the steering column. In more advance factory installed system, this module can receive feed-back signals from the electronic control module (ECM) of the vehicle about the speed and other driving conditions. This module is also provided with an on-off switch.

As the power is turned on, the system goes to a standby mode and this standby mode is indicated by a visual indicator. As the drivers grips the steering wheel for driving, the contact inside the tube is made and the module goes to an active mode which is indicated by a visual indicator. During driving, as soon as the steering grip is relaxed due to any reason the contact inside the hollow tube opens up and the module switches to alarm mode. At this mode the module goes through a set of wait cycle which depends on feed-back from the ECM of the vehicle and/or data stored during learning mode. At the end of the wait time an audio-visual alarm goes off. This alarm is again time and speed sensitive.

### BRIEF DESCRIPTION OF THE DRAWINGS

FIG. 1 is a perspective view of a typical steering wheel and steering column of a vehicle showing collapsible-flexible hollow tube glued on the back side of the steering wheel all along its circumference. The electronic sensing and signaling module (ESSM) is placed/affixed on the steering web.

FIG. 2 is a sectional view of the steering wheel along with the sectional view of the hollow collapsible-flexible tube showing two conductive element, affixed on the back side of the steering wheel.

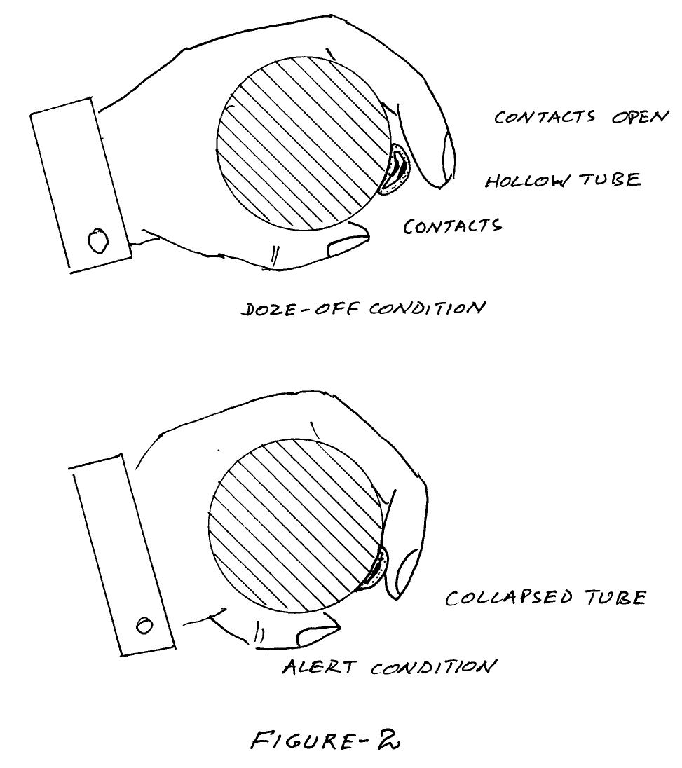

FIG. 3 is a schematic of signal flow and process order, in general for the this doze-off alarm system.

### DETAILED DESCRIPTION OF THE PREFFERED EMBODIMENT

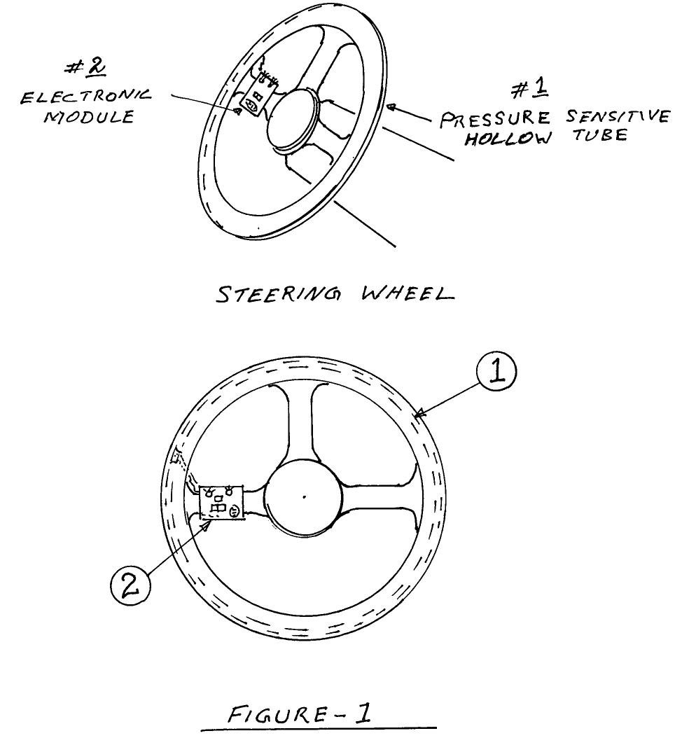

As best illustrated in FIG. 1, the early doze-off warning system for automotive is essentially (but not limited to) composed of two major functional components.

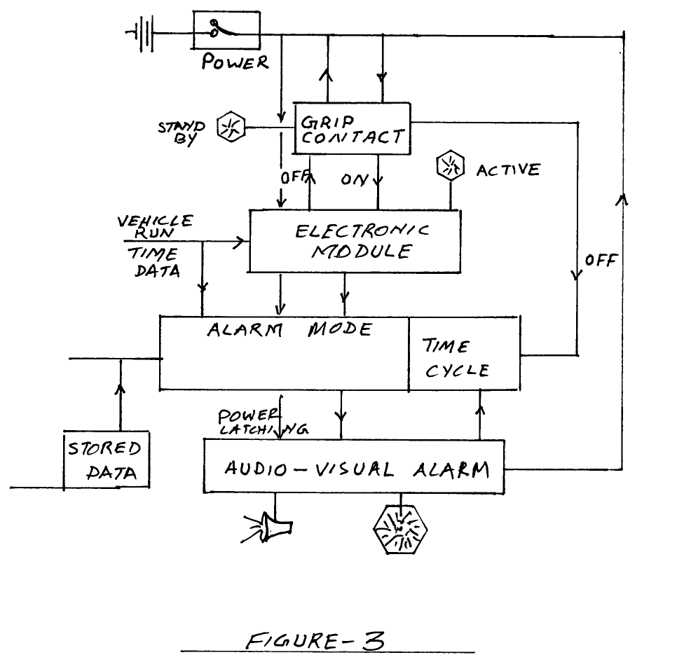

Components # 1, as best illustrated in FIG. 1 thru FIG. 3 is a grip sensing component, it is a hollow tube which is flexible and collapsible, made of rubber or like material, having certain wall thickness, which would collapse under normal grip pressure of the driver's forefingers on the steering wheel of the vehicle. Component # 1 is further integrated with other components as follows;

A. Two conductive elements are fused/attached permanently on the inside surface of the component # 1 face to face in a manner that a positive contact is made when the hollow tube is collapsed.

B. A single/double pin micro plug is provided at one end of each conductive element, component # 1(A)

Component # 2, as best illustrated in FIG. 1 thru FIG. 3 is an electronic sensing and signaling module (ESSM) essentially (but not limited to) providing following functions in general.

A. Power source and/or power connection

B. On-Off switch to the doze-off system

C. Standby mode and standby indicator

D. Active mode and active indicator

E. Time delay analysis and applications

F. Data storage obtained during learning mode

G. Learning mode capability

H. Audio-visual alarming functions

I. Feed-in and feed-back functions

J. Latching functions

This component # 2 includes solid state electronic circuits and circuit components to perform required functions in conjunction with component # 1 and feed-back signal from other systems in the vehicle.

FIG. 3 is a schematic of signal flow and process order, in general for this doze-off early warning system. As the power is turned on, the system goes to a standby mode and this standby mode is indicated by a visual indicator. As the drivers grips the steering wheel for driving, the contact inside the tube is made and the module goes to an active mode which is indicated by a visual indicator. During this active mode the ESSM (component # 2) receives data relating to the operation of the vehicle from the on-board computer of the vehicle. For retrofit models of this invention feed-in circuit is not necessary for normal operation.

During driving, as soon as the steering grip is relaxed due to any reason, such as doze-off, the contact inside the hollow tube opens up and the module switches to the alarm mode. At this mode the module goes through a set of wait cycle which depends on feed-back from the ECM of the vehicle and/or data stored during learning mode. At the end of the wait time an audio-visual alarm goes off.

This alarm is again time and speed sensitive and timed out depending on some parameters stored during learning mode or as a feedback from the system of the vehicle. As soon as the alarms times out, the system goes to standby mode or active mode depending on the grip condition or the driving condition.

I claim:

1. A Doze-off early warning system for automotive and other application essentially composed of a collapsible-flexible tube made of rubber or like material to act as grip sensitive component, and a solid state electronic sensing and signaling module.

2. Doze-off early warning system in claim # 1, is composed of a hollow collapsible-flexible tube made of rubber or like material, to be installed all along the circumference of the steering wheel of any vehicle with glue or self adhesive substance.

3. The Hollow collapsible-flexible tube in claim # 2 is affixed or fused with two conductive elements on the inside surface of the hollow tube in claim # 2, face to face all along its length.

4. The conductive element in claim # 3 has micro pin plugs at either end.

5. An electronic sensing and control module (ESSM) which provide all essential functions of the doze-off early warning system.

6. The ESSM in claim # 5 is provided with a power source and power on-off switch.

7. The ESSM in claim # 5 is provided with a standby mode circuit and standby mode visual indicator.

8. The ESSM in claim# 5 is provided with a active mode circuit and active mode visual indicator.

9. The ESSM in claim # 5 is provided with a time delay analysis and time delay application circuit.

10. The ESSM in claim # 5 is provided with a learning mode circuit and a learning mode data storage device.

11. The ESSM in claim # 5 is provided with a audio and visual alarming device.

12. The ESSM in claim # 5 is provided with a feed-back and feed-in circuit.

13. The ESSM in claim # 5 is provided with a latching circuit for required functions.

14. All the components in claim # 1 thru claim # 13 are connected via solid state medium to perform the required function.
